(19) United States
(12) Patent Application Publication
(10) Pub. No.: US 2026/0114456 A1
(43) Pub. Date: Apr. 30, 2026

(54) Snake Deterrent Composition

(71) Applicant: Kurtis Broadnax, Olympia, WA (US)

(72) Inventor: Kurtis Broadnax, Olympia, WA (US)

(21) Appl. No.: 18/931,768

(22) Filed: Oct. 30, 2024

(51) Int. Cl. A01N 65/12; A01N 25/04; A01N 65/08; A01N 65/22; A01N 65/24; A01N 65/38; A01N 65/40; A01N 65/42; A01N 65/44; A01P 17/00

(52) U.S. Cl. CPC A01N 65/12; A01N 25/04; A01N 65/08; A01N 65/22; A01N 65/24; A01N 65/385; A01N 65/40; A01N 65/42; A01N 65/44; A01P 17/00

(57) ABSTRACT

A snake deterrent composition for repelling snakes from a person or area includes a Tagetes that is between 8.0% and 12.0% of the ingredients on a volume/volume basis. Each of a Dracaena trifasciata, a Cymbopogon, a Salvia Rosmarinus, an Ageratina, an Ocimum gratissimum, and a Cinnamomum verum are also between 8.0% and 12.0% of the ingredients on the volume/volume basis. The volume/volume basis is determined by a total volume of the ingredients. Each of a Turnera ulmifolia, a Nicotiana tabacum, an Artemisia absinthium, and a Tulbaghia violacea are between 3.0% and 7.0% of the ingredients on the volume/volume basis.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to snake repellents and more particularly pertains to a new snake repellent for repelling snakes from a person or area.

### (2) Description of Related Art Including Information Disclosed Under 37 CFR 1.97 and 1.98

The prior art relates to snake repellents. Snakes can be frightening, particularly because some snakes are highly dangerous. For example, some snakes are highly venomous, and it can be difficult for the general public to differentiate between venomous and non-venomous snake species. In the United States, there are roughly 7,000 to 8,000 venomous snake bites per year. Thus, there is a need for a snake repellent solution that is safe for humans and pets. Ideally, such a solution would be easy to apply either directly onto a human's body, or on the ground or floor of around the perimeter of an area the user wants to keep free of snakes.

### BRIEF SUMMARY OF THE INVENTION

An embodiment of the disclosure meets the needs presented above by generally comprising a solution of ingredients that is configured to repel snakes. The ingredients include a Tagetes that is between 8.0% and 12.0% of the ingredients on a volume/volume basis. The volume/volume basis is determined by a total volume of the ingredients. A Turnera ulmifolia is between 3.0% and 7.0% of the ingredients on the volume/volume basis. A Dracaena trifasciata is between 8.0% and 12.0% of the ingredients on the volume/volume basis. A Cymbopogon is between 8.0% and 12.0% of the ingredients on the volume/volume basis. A Salvia rosmarinus is between 8.0% and 12.0% of the ingredients on the volume/volume basis. A Nicotiana tabacum is between 3.0% and 7.0% of the ingredients on the volume/volume basis. An Artemisia absinthium is between 3.0% and 7.0% of the ingredients on the volume/volume basis. A Tulbaghia violacea is between 3.0% and 7.0% of the ingredients on the volume/volume basis. An Ageratina is between 8.0% and 12.0% of the ingredients on the volume/volume basis. An Ocimum gratissimum is between 8.0% and 12.0% of the ingredients on the volume/volume basis. A Cinnamomum verum is between 8.0% and 12.0% of the ingredients on the volume/volume basis.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a snake deterrent composition according to an embodiment of the disclosure.

FIG. 2 is a block diagram view of an embodiment of the disclosure.

FIG. 3 is an in-use view of an embodiment of the disclosure.

FIG. 4 is an in-use view of an embodiment of the disclosure.

FIG. 5 is a block diagram view of an embodiment of the disclosure.

FIG. 6 is a block diagram view of an embodiment of the disclosure.

### DETAILED DESCRIPTION OF THE INVENTION

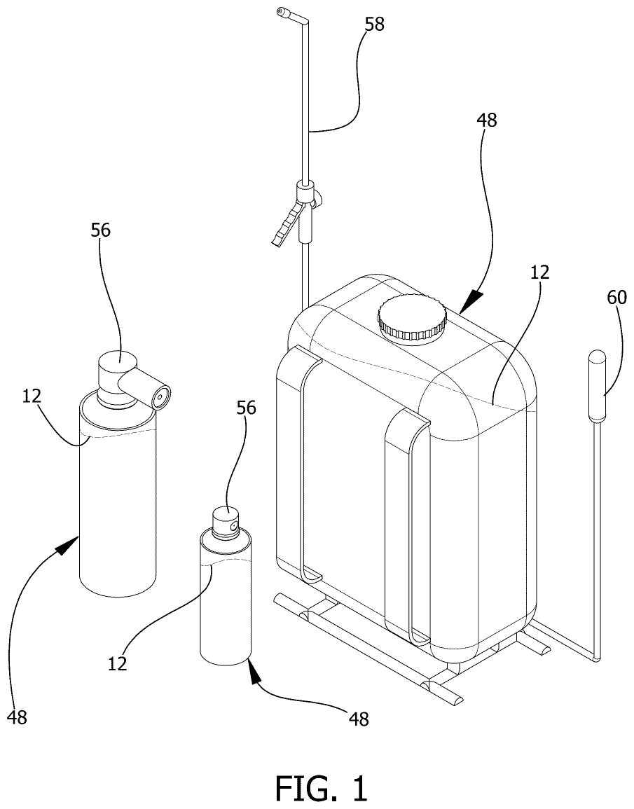

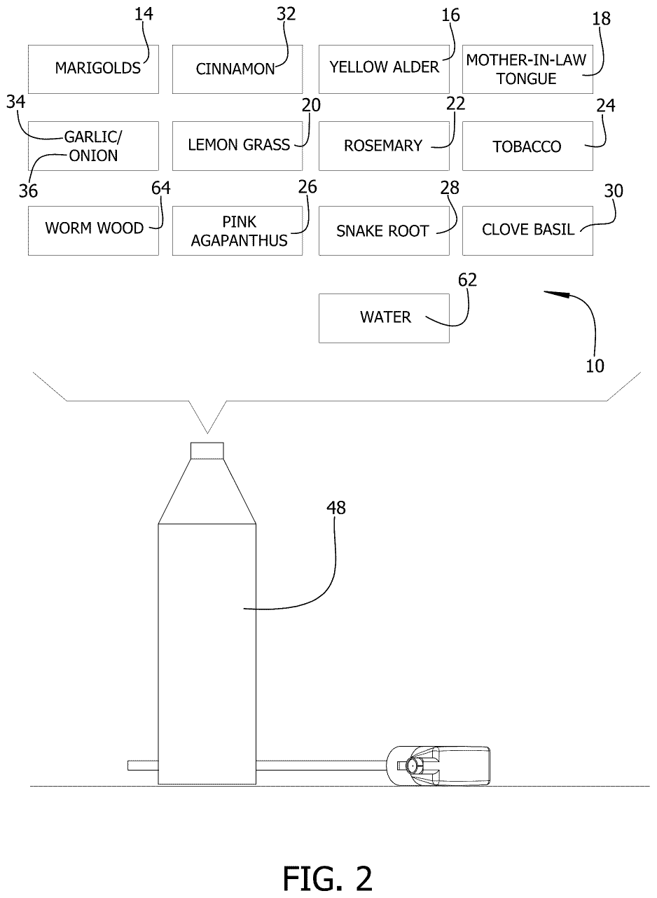

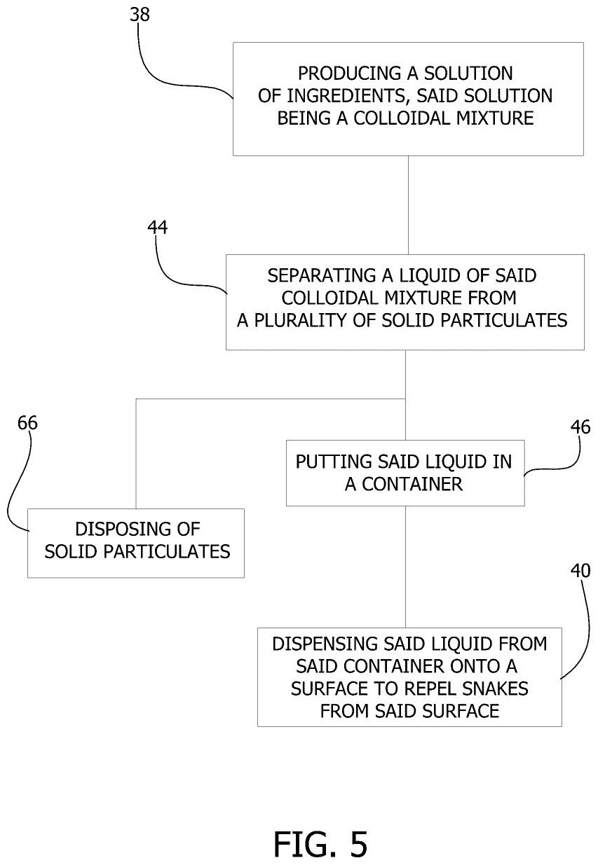

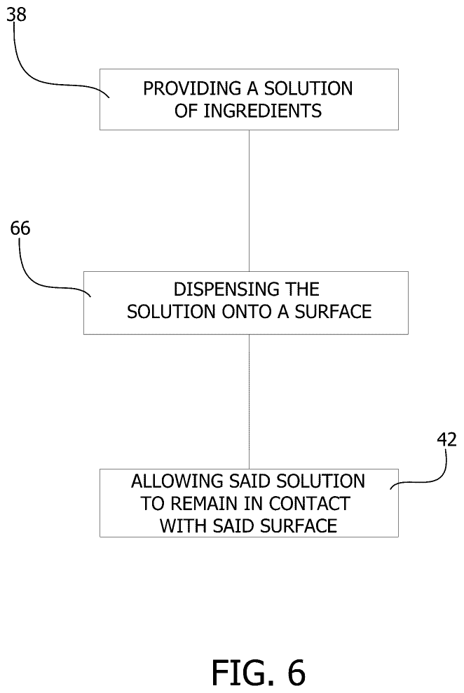

With reference now to the drawings, and in particular to FIGS. 1 through 6 thereof, a new snake repellent embodying the principles and concepts of an embodiment of the disclosure and generally designated by the reference numeral 10 will be described.

As best illustrated in FIGS. 1 through 6, the snake deterrent composition 10 generally comprises a solution 12 of ingredients may be blended together, or otherwise combined. The solution 12 of ingredients is configured to repel snakes 50 from a surface 54 on which the solution 12 of ingredients is dispensed. The ingredients generally include plants, or extracts from plants. For example, the ingredients may include plant matter that is blended together with a water base 62. The water base 62 is generally a minimal amount of the solution 12, with just enough of the water base 62 is added to the ingredients to allow the ingredients to form a liquid when the ingredients are combined. For example, the water base 62 may be between 1.5% and 7.0% of the ingredients on a volume/volume basis. The volume/volume basis is generally determined by a total volume of the ingredients

The ingredients generally include a Tagetes 14. The Tagetes 14 may be between 8.0% and 12.0% of the ingredients on the volume/volume basis. The Tagetes 14 is more commonly known as marigold. A Turnera ulmifolia 16 is generally between 3.0% and 7.0% of the ingredients on the volume/volume basis. The Turnera ulmifolia 16 is more commonly known as yellow alder. A Dracaena trifasciata 18 may be between 8.0% and 12.0% of the ingredients on the volume/volume basis. The Dracaena trifasciata 18 is more commonly known as mother-in-law's tongue. A Cymbopogon 20 may be between 8.0% and 12.0% of the ingredients on the volume/volume basis. The Cymbopogon 20 is more commonly known as lemongrass. A Salvia rosmarinus 22 may be between 8.0% and 12.0% of the ingredients on the volume/volume basis. The Salvia rosmarinus 22 is more commonly known as rosemary. A Nicotiana tabacum 24 may be between 3.0% and 7.0% of the ingredients on the volume/volume basis. The Nicotiana tabacum 24 is more commonly known as cultivated tobacco. An Artemisia absinthium 64 may be between 3.0% and 7.0% of the ingredients on the volume/volume basis. The Artemisia absinthium 64 is more commonly known as wormwood. A Tulbaghia violacea 26 may be between 3.0% and 7.0% of the ingredients on the volume/volume basis. The Tulbaghia violacea 26 is more commonly known as pink agapanthus. An Ageratina 28 may be between 8.0% and 12.0% of the ingredients on the volume/volume basis. The Ageratina 28 is more commonly known as snakeroot. An Ocimum gratissimum 30 may be between 8.0% and 12.0% of the ingredients on the volume/volume basis. The Ocimum gratissimum 30 is more commonly known as clove basil. A Cinnamomum verum 32 may be between 8.0% and 12.0% of the ingredients on the volume/volume basis. The Cinnamomum verum 32 is more commonly known as cinnamon.

The ingredients may also include an Allium sativum 34, which may be between 1.5% and 7.0% of the ingredients on the volume/volume basis. The Allium sativum 34 is more commonly known as garlic clove. The ingredients may also include an Allium cepa 36, which may be between 1.5% and 7.0% of the ingredients on the volume/volume basis. The Allium cepa 36 is more commonly known as onion. For example, some embodiments of the solution 12 may include the Allium sativum 34 in between 1.5% and 3.0% of the ingredients on the volume/volume basis, along with the Allium cepa 36 in between 1.5% and 3.0% of the ingredients on the volume/volume basis. Other embodiments of the solution 12 may include only one of the Allium sativum 34 and the Allium cepa 36. In those embodiments, either the Allium sativum 34 or the Allium cepa 36 may be between 3.0% and 7.0% of the ingredients on the volume/volume basis.

In use, a corresponding method of repelling reptiles, such as snakes 50, may include providing 38, or producing 38, the solution 12 of ingredients. When the method includes producing 38 the solution 12, the ingredients may be blended together with the water base 62. The solution 12 may define a colloidal mixture having a plurality of solid particulates suspended in a liquid. Such methods may further include separating 44 the plurality of solid particulates from the liquid, for example by straining the colloidal mixture. The method may further include disposing 66 of the plurality of solid particulates. The method may further include putting 46 the liquid into a container 48. The method may further include dispensing 40 the solution 12, or the liquid portion of the colloidal mixture, from the container 48 onto a surface 54 wherein the liquid is configured to repel snakes 50 from the surface 54. The solution 12 may be allowed to remain in contact with the surface 54, for example until the surface 54 is cleaned or the solution 12 is removed by rain, wind, or other weather conditions.

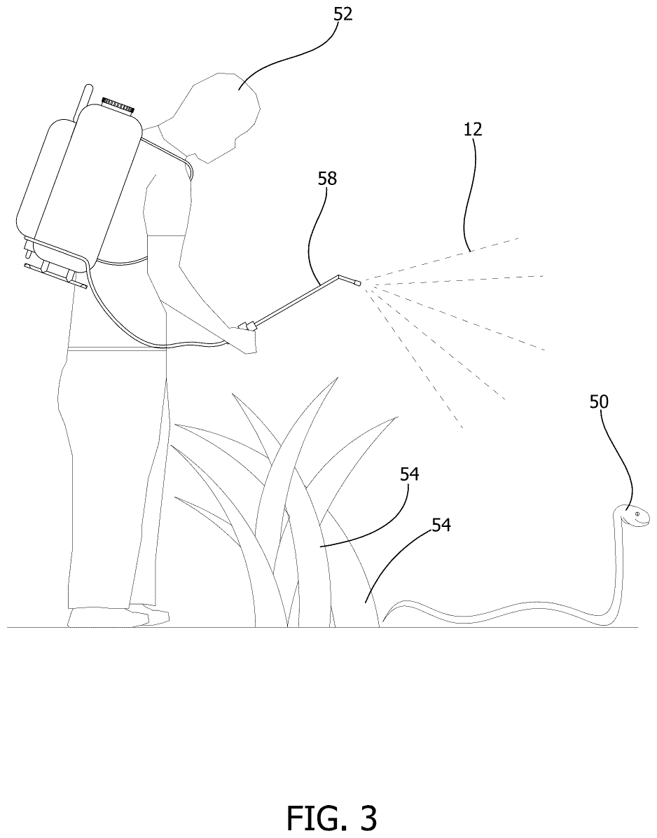

For example, the container 48 may be a spray bottle, and the liquid may be dispensed from the container 48 by spraying the liquid outwardly from the spray bottle. The surface 54 may be an area of the ground, or the floor, as shown in FIG. 3. In such embodiments, the surface 54 may also include plants, structures, and other objects which are on the ground or floor. A user 52 may dispense 40 the solution 12 around a perimeter of an area that the user 52 wants to remain free of snakes 50, such as the perimeter of a yard or a room.

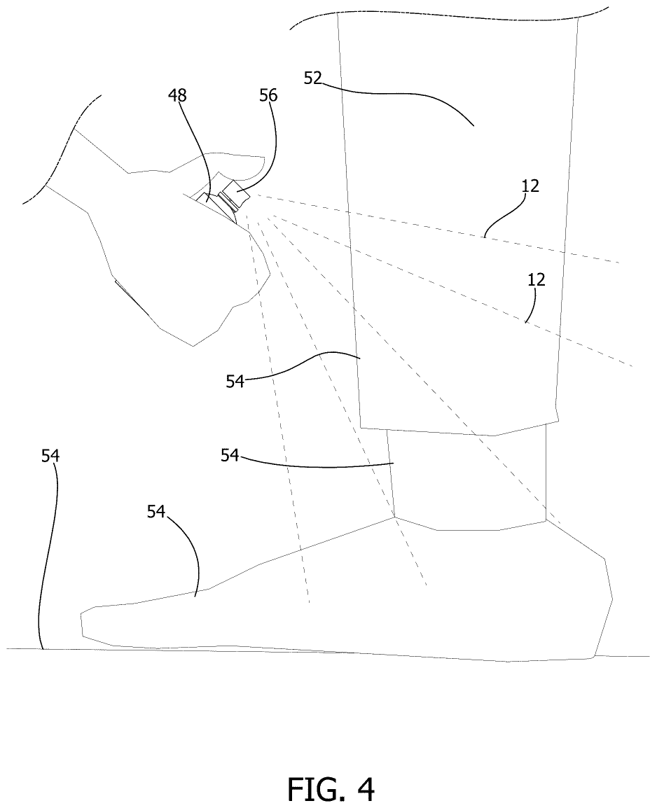

The surface 54 may also be a garment that is worn by the user 52, or the skin of the user 52. For example, as shown in FIG. 4, the liquid of the solution 12 may be sprayed directly onto the feet, ankles, and calves of the user 52 to repel snakes 50 from the user 52 as the user 52 walks through a field or other area where snakes 50 may be located.

For example, the container 48 may be a spray bottle. Exemplary spray bottles are provided in FIG. 1. For example, the container 48 may be a small, personal use spray bottle, for example that is about 4.0″ tall, with a finger pump 56. Other embodiments of the spray bottle may be slightly larger or smaller. As shown in FIG. 4, such small, personal use spray bottles may be used to dispense 40 the solution 12 onto the surface 54.

In other embodiments, the spray bottle could be larger, for example holding between approximately 0.5 gallons and 1.5 gallons of the solution 12. In such embodiments, the container 48 may have a wand 58 for dispensing the solution 12 while the solution 12 is under pressure. In such embodiments, the container 48 may also include a lever 60 that is pivotable upward and downward to increase pressure inside the container 48 as the solution 12 is dispensed 40 from the container 48.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A reptile repellant composition comprising:
a solution of ingredients being configured to repel snakes, the ingredients combined on a volume/volume basis, the volume/volume basis being determined by a total volume of the ingredients, the ingredients including:
a Tagetes;
a Turnera ulmifolia;
a Dracaena trifasciata;
a Cymbopogon;
a Salvia rosmarinus;
a Nicotiana tabacum;
an Artemisia absinthium;
a Tulbaghia violacea;
an Ageratina;
an Ocimum gratissimum; and
a Cinnamomum verum.

2. The reptile repellant composition of claim 1, the ingredients further comprising an Allium sativum being between 1.5% and 3.0% of the ingredients on the volume/volume basis.

3. The reptile repellant composition of claim 2, the ingredients further comprising an Allium cepa being between 1.5% and 3.0% of the ingredients on the volume/volume basis.

4. The reptile repellant composition of claim 1, the ingredients further comprising an Allium sativum being between 3.0% and 7.0% of the ingredients on the volume/volume basis.

5. The reptile repellant composition of claim 1, the ingredients further comprising an Allium cepa being between 3.0% and 7.0% of the ingredients on the volume/volume basis.

6. The reptile repellant composition of claim 1, wherein
the Tagetes is between 8.0% and 12.0% of the ingredients on the volume/volume basis;
the Turnera ulmifolia is between 3.0% and 7.0% of the ingredients on the volume/volume basis;
the Dracaena trifasciata is between 8.0% and 12.0% of the ingredients on the volume/volume basis;
the Cymbopogon is between 8.0% and 12.0% of the ingredients on the volume/volume basis;
the Salvia rosmarinus is between 8.0% and 12.0% of the ingredients on the volume/volume basis;
the Nicotiana tabacum is between 3.0% and 7.0% of the ingredients on the volume/volume basis;
the Artemisia absinthium is between 3.0% and 7.0% of the ingredients on the volume/volume basis;
the Tulbaghia violacea is between 3.0% and 7.0% of the ingredients on the volume/volume basis;
the Ageratina is between 8.0% and 12.0% of the ingredients on the volume/volume basis;
the Ocimum gratissimum is between 8.0% and 12.0% of the ingredients on the volume/volume basis; and
the Cinnamomum verum is between 8.0% and 12.0% of the ingredients on the volume/volume basis.

7. A reptile repellant composition comprising:
a solution of ingredients being combined together, the solution of ingredients being configured to repel snakes from a surface on which the solution of ingredients is dispensed, the ingredients including:
a Tagetes being between 8.0% and 12.0% of the ingredients on a volume/volume basis, the volume/volume basis being determined by a total volume of the ingredients;
a Turnera ulmifolia being between 3.0% and 7.0% of the ingredients on the volume/volume basis;
a Dracaena trifasciata being between 8.0% and 12.0% of the ingredients on the volume/volume basis;
a Cymbopogon being between 8.0% and 12.0% of the ingredients on the volume/volume basis;
a Salvia rosmarinus being between 8.0% and 12.0% of the ingredients on the volume/volume basis;
a Nicotiana tabacum being between 3.0% and 7.0% of the ingredients on the volume/volume basis;
an Artemisia absinthium being between 3.0% and 7.0% of the ingredients on the volume/volume basis;
a Tulbaghia violacea being between 3.0% and 7.0% of the ingredients on the volume/volume basis;
an Ageratina being between 8.0% and 12.0% of the ingredients on the volume/volume basis;
an Ocimum gratissimum being between 8.0% and 12.0% of the ingredients on the volume/volume basis; and
a Cinnamomum verum being between 8.0% and 12.0% of the ingredients on the volume/volume basis;
an Allium sativum being between 1.5% and 3.0% of the ingredients on the volume/volume basis; and
an Allium cepa being between 1.5% and 3.0% of the ingredients on the volume/volume basis.

8. A method of repelling reptiles comprising:
providing a solution of ingredients, the ingredients including:
a Tagetes being between 8.0% and 12.0% of the ingredients on a volume/volume basis, the volume/volume basis being determined by a total volume of the ingredients;
a Turnera ulmifolia being between 3.0% and 7.0% of the ingredients on the volume/volume basis;
a Dracaena trifasciata being between 8.0% and 12.0% of the ingredients on the volume/volume basis;
a Cymbopogon being between 8.0% and 12.0% of the ingredients on the volume/volume basis;
a Salvia rosmarinus being between 8.0% and 12.0% of the ingredients on the volume/volume basis;
a Nicotiana tabacum being between 3.0% and 7.0% of the ingredients on the volume/volume basis;
an Artemisia absinthium being between 3.0% and 7.0% of the ingredients on the volume/volume basis;
a Tulbaghia violacea being between 3.0% and 7.0% of the ingredients on the volume/volume basis;
an Ageratina being between 8.0% and 12.0% of the ingredients on the volume/volume basis;
an Ocimum gratissimum being between 8.0% and 12.0% of the ingredients on the volume/volume basis; and
a Cinnamomum verum being between 8.0% and 12.0% of the ingredients on the volume/volume basis;
an Allium sativum being between 1.5% and 7.0% of the ingredients on the volume/volume basis; and
an Allium cepa being between 1.5% and 7.0% of the ingredients on the volume/volume basis;
a water base being between 3.0% and 7.0% of the ingredients on the volume/volume basis; and
dispensing the solution, the solution being configured to be dispensed onto a surface wherein the solution is configured to repel snakes from the surface.

9. The method of repelling reptiles of claim 8, the solution further comprising a colloidal mixture having a plurality of solid particulates suspended in a liquid, the method further comprising:
separating the plurality of solid particulates in the colloidal mixture from the liquid; and
putting the liquid into a container, the liquid being configured to be dispensed from the container onto the surface.

10. The method of repelling reptiles of claim 9, wherein the container is a spray bottle.

11. The method of repelling reptiles of claim 9, the method further comprising disposing of the solid particulates from the colloidal mixture.

12. The method of repelling reptiles of claim 9, wherein the plurality of solid particulates are separated from the liquid by straining the colloidal mixture.
